(19) United States
(12) Patent Application Publication
(10) Pub. No.: US 2002/0009977 A1
(43) Pub. Date: Jan. 24, 2002

(54) Portable telephone set

(76) Inventors: Kazuhito Sato, Kanagawa (JP); Yasuharu Matsubara, Miyagi (JP)

Correspondence Address: COOPER & DUNHAM LLP, 1185 Avenue of the Americas, New York, NY, 10036, US

(21) Appl. No.: 09/844,041

(22) Filed: Apr. 27, 2001

(30) Foreign Application Priority Data
Apr. 28, 2000 (JP) P2000-130679

(51) Int. Cl. H04B 1/38

(52) U.S. Cl. 455/90; 455/575; 455/66

(57) ABSTRACT

The present invention provides a portable telephone set, which is capable of being carried by the user by being hooked up on the belt of a belt clip. At the same time, the belt clip does not form an obstacle for the user when he or she uses the telephone set.

### BACKGROUND OF THE INVENTION

1. Field of the Invention

The present invention relates to a portable telephone set and particularly to a portable telephone set, which can be held by being hooked up on a user's belt or the like.

2. Description of the Related Art

For example, it would be convenient to hold a cordless handset of an extension phone by having it hooked up on a belt of a user's pants.

Conventionally, in order to hook up a telephone set on a belt or the like, telephone sets attached with a belt clip as a holding member have been put to practical use.

As shown in FIG. 11, in regard to the conventional telephone set with a belt clip of this type, a belt clip 2 is retrofitted to a body of a telephone set body 1. In other words, the belt clip 2 is installed to the telephone set body 1 from a rear side thereof in such a manner that engaging claws 2a and 2b, which are attached to the right and left sides of the belt clip 2 are incorporated in engaging convex portions 3a and 3b on the both sides of the telephone set body 1. In this state, by hooking up a clip element 2c of the belt clip 2 on the belt of the pants so as to put the belt between the telephone set body 1 and the clip element 2c, the telephone set body 1 can be carried by the user while being held by the belt of the user's pants.

However, if the telephone set is used with the belt clip is attached thereto in this case, this involves a problem such that this belt clip incurs inconvenience for the user when he or she holds the telephone set by hand. Although the telephone set of this type can be used normally if the belt clip is detached, the user has to find the belt clip to install it to the telephone set when he or she wants to hook up the telephone set on the belt. Therefore, it has caused inconvenience and it has been hard to handle the conventional telephone set.

### SUMMARY OF INVENTION

The present invention has been implemented in view of such problems and an object thereof is to provide a portable telephone set having a holding member (a belt clip), which is attached to the portable telephone set body to hold the body by hooking it up on a user's belt. Further, this holding member is attached movably and stored in a storage portion of the portable telephone set body when the holding member is not used.

With regard to such a portable telephone set according to the present invention, when the user wishes to use the holding member, he or she can immediately pull out the holding member of the storage portion to have the holding member be in a state of being used any time. Alternatively, the holding member does not incur any obstacle for the user when he or she holds the telephone set by hand, since the holding member is capable of being stored in the storage portion of the portable telephone set body when the holding member is not used.

### BRIEF DESCRIPTION OF THE DRAWINGS

FIG. 1 is a perspective view from a rear side of a portable telephone set according to the present invention;

FIG. 2 is a front view of the portable telephone set according to the present invention;

FIG. 3 is a side view of the portable telephone set according to the present invention, wherein FIG. 3(A) illustrates a state that a belt clip is stored and FIG. 3(B) illustrates a state that the belt clip is available;

FIG. 4 is a rear view of the portable telephone set according to the present invention;

FIG. 5 is a longitudinal sectional side view for illustrating a movable mechanism of the belt clip, wherein FIG. 5(A) illustrates a state that the belt clip is stored and FIG. 5(B) illustrates a state that the belt clip is available;

FIG. 6 is a longitudinal sectional side view for illustrating an engagement mechanism of the belt clip in an example of FIG. 5, wherein FIG. 6(A) illustrates a state that the belt clip is stored and FIG. 6(B) illustrates a state that the belt clip is available;

FIG. 7 is a longitudinal sectional side view for illustrating another example of a movable mechanism of the belt clip, wherein FIG. 7(A) illustrates a state that the belt clip is stored and FIG. 7(B) illustrates a state that the belt clip is available;

FIG. 8 is a longitudinal sectional side view for illustrating further example of a movable mechanism of the belt clip, wherein FIG. 8(A) illustrates a state that the belt clip is stored and FIG. 8(B) illustrates a state that the belt clip is available;

FIG. 9 is a longitudinal sectional side view for illustrating sill further example of a movable mechanism of the belt clip, wherein FIG. 9(A) illustrates a state that the belt clip is stored and FIG. 9(B) illustrates a state that the belt clip is available;

FIG. 10 is a longitudinal sectional side view for illustrating an engagement mechanism of the belt clip in an example of FIG. 9; and

FIG. 11 is an explanatory drawing of a conventional example.

### DETAILED DESCRIPTION OF THE PREFERRED EMBODIMENTS

The embodiments of the present invention will be described with reference to the attached drawings below.

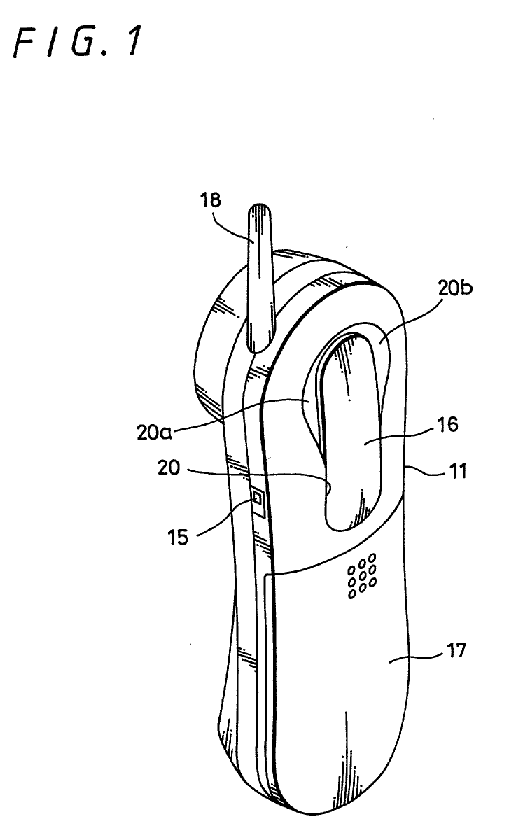

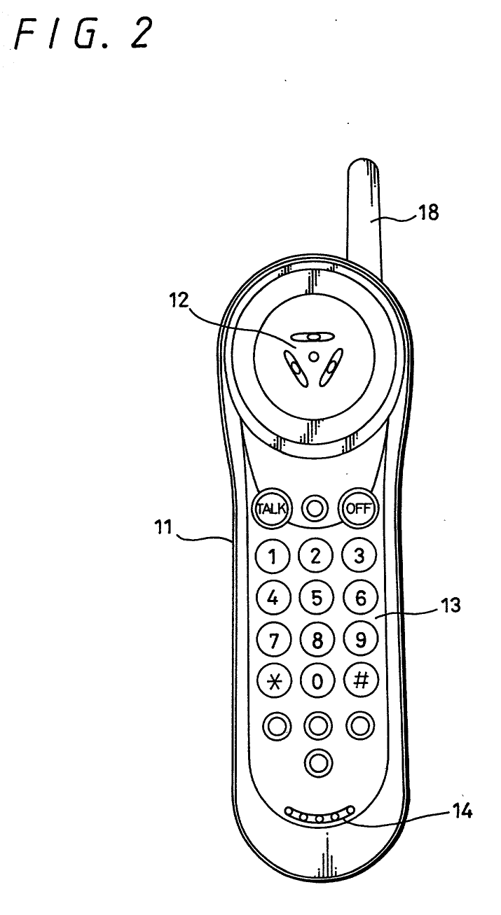

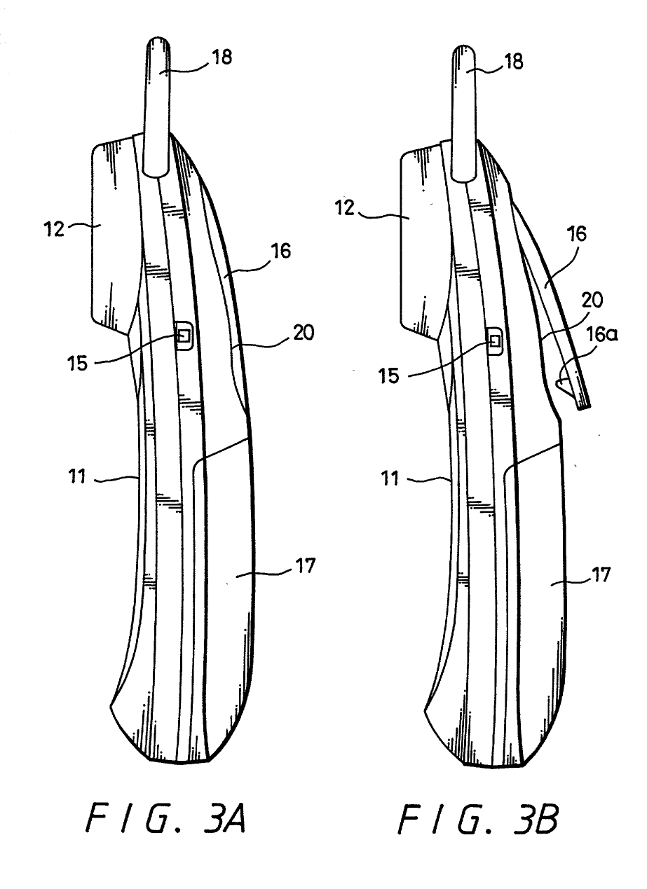

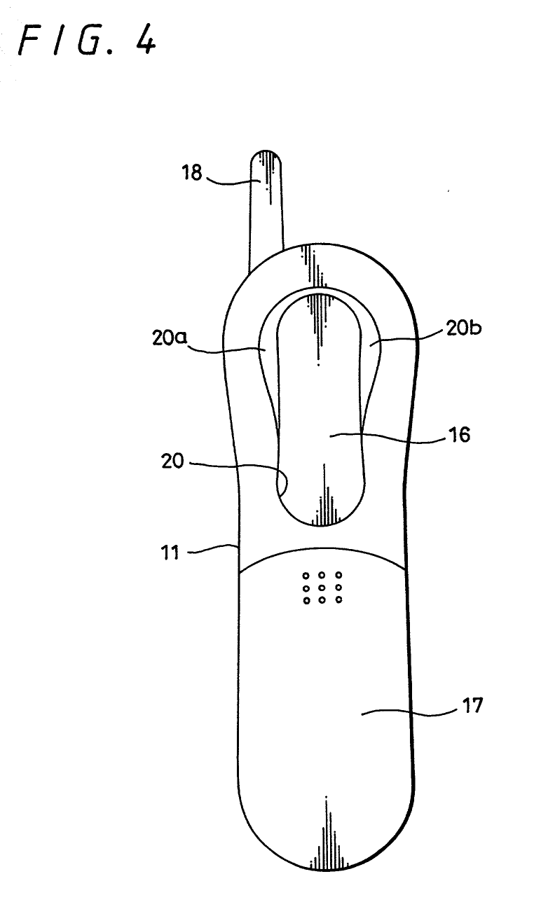

According to the present embodiment, a cordless handset of an extension phone is illustrated by an example of a portable telephone set. FIG. 1 is a perspective view from a rear side of a portable telephone set according to the present invention. FIG. 2 is a front view of the portable telephone set according to the present invention. FIG. 3 is a side view of the portable telephone set according to the present invention. FIG. 4 is a rear view of the portable telephone set according to the present invention.

As shown in FIG. 2, at the front of a portable telephone set body 11 of this portable telephone set, a speaker portion 12 for receiving a call is arranged on an upper portion thereof, an operation portion 13 having various kinds of operational keys including a numeric keypad is arranged on a central portion thereof and a microphone portion 14 for sending a call is arranged on a lower portion thereof.

Alternatively, as shown in FIG. 3, at a side face of the portable telephone set body 11, a switch 15 for adjusting a receiving sound volume is disposed.

As shown in FIG. 4, at a rear face of the portable telephone set body 11, a belt clip 16 is disposed on an upper portion thereof and a battery storage portion 17 is disposed on a lower portion thereof.

Further, at an upper end of the portable telephone set body 11, an antenna 18 for transmission and reception to and from the main phone is provided sticking upward.

In this telephone set, the belt clip 16 to be disposed on the rear face of the portable telephone set body 11 comprises a holding member for holding the portable telephone set body 11 by hooking it up on a user's belt or the like.

The belt clip 16 will be explained more in detail below.

This belt clip 16 comprises a ligulate plate element, which is elongated to up and down, and it is incorporated in the portable telephone set body 11 by being exposed to the rear side of the portable telephone set body 11.

According to the present example, this belt clip 16 has a swingably movable structure. In other words, this belt clip 16 is incorporated in the portable telephone set body 11 by being made swingable with the upper portion thereof as a fulcrum with respect to the portable telephone set body 11. When the user does not use the belt clip 16, it is stored in a convex storage portion 20 provided on the portable telephone set body 11 as shown in FIG. 3(A). When the user uses the belt clip 16, he or she pulls out a lower portion of the belt clip 16 of the storage portion 20 by swinging it as shown in FIG. 3(B), so that the belt clip 16 is in available condition.

This movable mechanism of the belt clip 16 will be explained in detail later on.

Under a state that the belt clip 16 is pulled out from the storage portion 20 to be available in this way, the belt clip 16 is hooked up on the belt of the user's pants so as to put the belt between the telephone set body 11 and the belt clip 16, so that the telephone set body 11 is carried by the user by being hung on the belt of the user's pants.

Alternatively, at a rear face of the lower portion of the belt clip 16, a projecting element 16a for preventing the dropping out is formed so that the belt clip 16 is hardly dropped out of the belt.

Thus, according to the telephone set of the present example, it is possible to pull out the belt clip 16 of the storage portion 20 and hook it up on the belt when the user uses the belt clip 16, so that it is convenient when the user is involved with various jobs outside as well as inside a house by carrying the telephone set with him or her. Further, when the user uses the telephone set, the belt clip 16 does not become a burden for the user when he or she holds the telephone set 11 by hand since the user can store the belt clip 16 in the storage portion 20.

Alternatively, according to the telephone set of the present example, in the state that the belt clip 16 is stored in the storage portion 20, a front face of the belt clip 16 constitutes the same level as that of the front face of the telephone set 11 and the belt clip 16 composes a portion of an outer shape of the telephone set 11 as shown in FIG. 3(A).

Therefore, according to the telephone set of the present example, the user is not bothered by a feeling of strangeness in terms of the design due to the existence of the belt clip 16, so that the outer shape of the telephone set can have a neat design.

Further, according to the telephone set of the present example, the storage portion 20, in which the belt clip 16 is stored, is formed in such a manner that a portion 20a and a portion 20b corresponding to the opposite sides of the upper portion with the swinging fulcrum of the belt clip 16 are partially spread as shown in FIG. 1 or FIG. 4.

In other words, there is a large space between the storage portion 20 and the belt clip 16 on both sides of the upper portion with the swinging fulcrum of the belt clip 16, so that it is possible to clip the belt up to as deeply as, for example, in the vicinity of the swinging fulcrum thereof when the user hooks up the belt clip 16 on the belt. Therefore, the user is capable of more surely holding the telephone set body 11 on the belt.

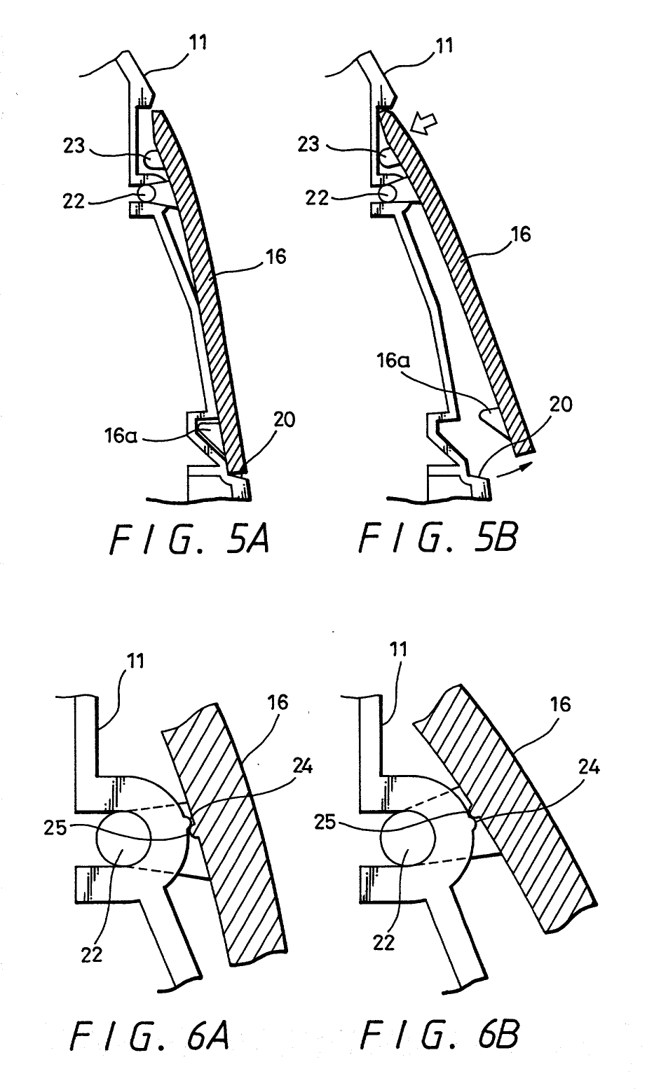

FIG. 5 illustrates the movable mechanism of the belt clip in detail.

According to the embodiment, a swingable shaft 22 is disposed on the rear face of the belt clip 16 in the direction near to the central portion at the downside from the upper portion of the belt clip 16 and the belt clip 16 is incorporated in the telephone set body 11 so as to be swingable around this swingable shaft 22 as a fulcrum.

In such a structure, the belt clip 16 is swinging like a seesaw. In other words, when the belt clip 16 is used, by compressing the upper end of the belt clip 16 toward the telephone set body 11 as shown in FIG. 5(B), the belt clip 16 is swung open in such a manner that the lower end of the opposing side of the swingable shaft 22 jumps out from the storage portion 20 to be available.

In this condition, a stopper prominence 23, which is provided on the rear face of the upper end of the belt clip 16, is struck to the telephone set body 11, so that the belt clip 16 is brought under control so as not to open any more.

Thus, according to the present example, the belt clip 16 has a structure to swing like a seesaw, so that it is possible to easily make the belt clip 16 available by compressing the upper end of the belt clip 16 toward the telephone set body 11 when the user uses the belt clip 16. In other words, it can be said that the telephone set according to the present invention has excellent operability.

Additionally, an engagement mechanism is provided in the movable mechanism of the belt clip to engagingly hold the belt clip 16 at the storage position and at the available position, respectively.

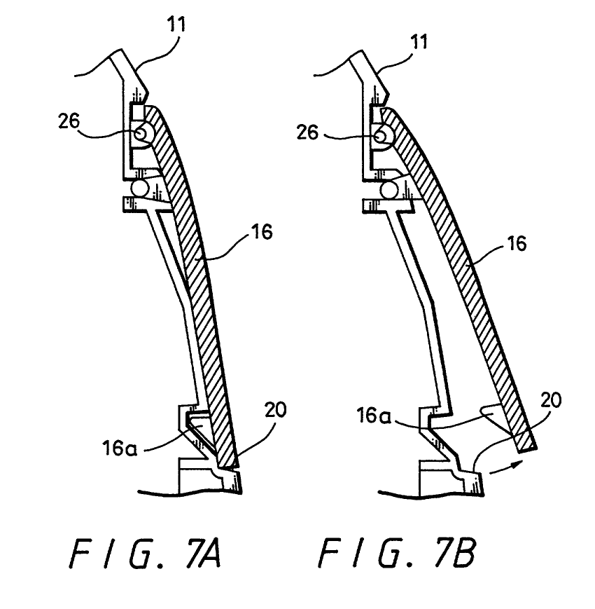

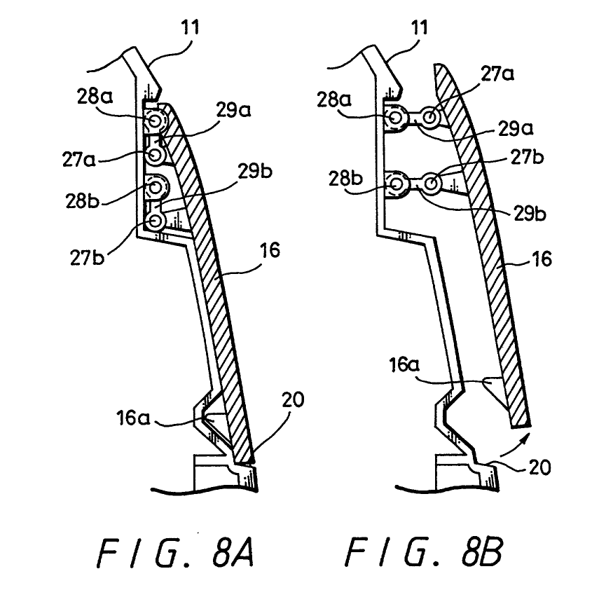

In other words, as shown in FIG. 6, this engagement mechanism is composed of an engagement prominence 24, which is disposed on the telephone set body 11, and an engagement prominence 25, which is disposed on the rear side of the belt clip 16, in the vicinity of a swing fulcrum (the swing shaft 22) of the belt clip 16. In the state that the belt clip 16 is stored in the storage portion 20, the engagement prominence 25 on the belt clip 16 is engaged with the lower portion of the engagement prominence 24 on the telephone set body 11 and the belt clip 16 is engagedly held at the same position as shown in FIG. 6(A). If the belt clip 16 is pulled out of the storage 20 to be available, as shown in FIG. 6(B), the engagement prominence 25 on the belt clip 16 climbs over the engagement prominence 24 on the telephone set body 11 to be engaged with the upper portion of the engagement prominence 24. As a result, the belt clip 16 can be engagedly held at this position.

Thus, according to this embodiment, disposing of the engagement mechanism for engaging and holding the belt clip 16 at the storage position and the available position, respectively, allows the belt clip 16 to be held reliably in the storage condition and the available condition, respectively. As a result, the telephone set according to the present invention is easily and conveniently used.

Alternatively, in this engagement mechanism, the feel of click can be obtained when the engagement prominence 25 of the belt clip 16 climbs over the engagement prominence 24 of the telephone set body 11. Therefore, it is possible to clearly recognize the storage condition and the available condition of the belt clip 16.

FIG. 7 illustrates another example of the movable mechanism of the belt clip. In other words, in this example, the swingable shaft 26 is disposed on the rear face side of the upper portion of the belt clip 16 and the belt clip 16 is swingably incorporated in the telephone set body 11 with this swingable shaft 26 of the upper portion as a swing fulcrum.

FIG. 8 illustrates further another example of the movable mechanism of the belt clip.

In this example, the belt clip 16 has a movable structure of a parallel moving system.

In other words, in this example, upper and lower shafts 27a and 27b, which are disposed on the upper rear face of the belt clip 16, and upper and lower shafts 28a and 28b, which are disposed on the telephone set body 11, are swingably coupled respectively on parallel links 29a and 29b. When these parallel links 29a and 29b are swung in parallel, the belt clip 16 moves parallelly between the storage position and the available position with respect to the telephone set body 11.

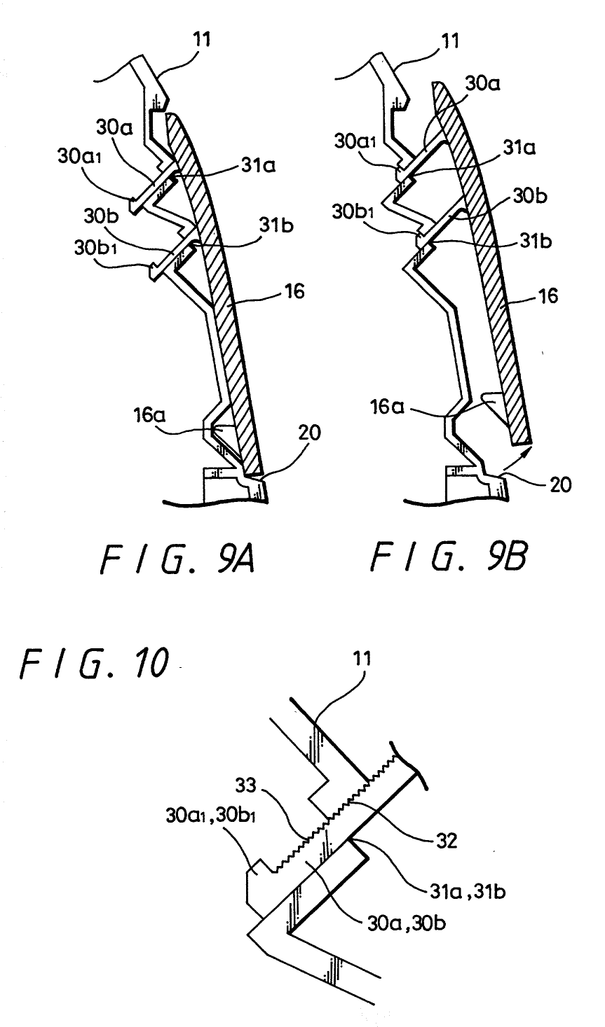

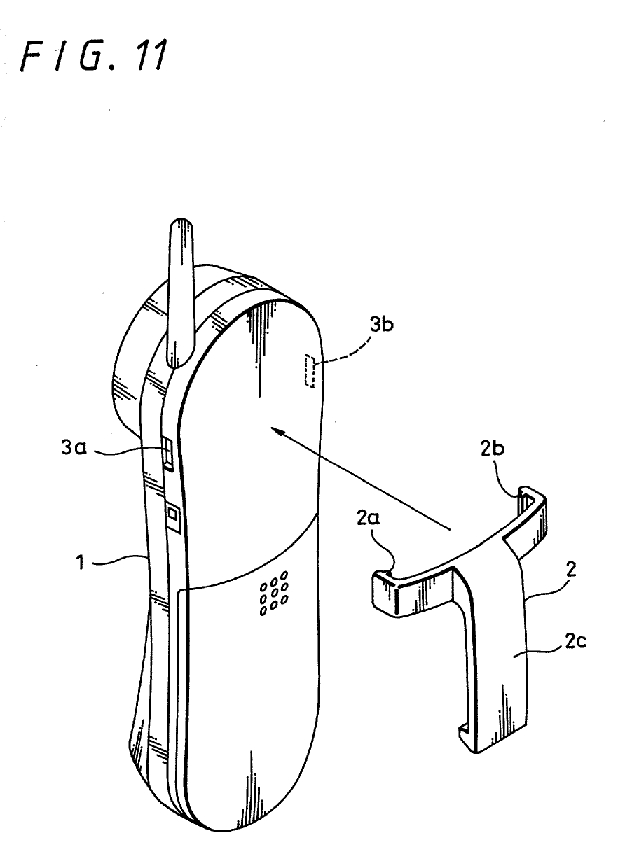

FIG. 9 illustrates sill further another example of a movable mechanism of the belt clip of a parallel moving system.

In this example, upper and lower parallel legs 30a and 30b, which are obliquely projectingly disposed on the rear face side of the upper portion of the belt clip 16, are inserted and supported slidably in supporting holes 31a and 31b on the telephone set body 11, respectively. The movable mechanism of the belt clip of a parallel moving system in this embodiment has a structure such that the belt clip 16 is obliquely moved parallelly between the storage position and the available position with respect to the telephone set body 11 by sliding these parallel legs 30a and 30b so that they disappear into and appear from these supporting holes 31a and 31b.

Alternatively, in this structure, convex portions 30a₁, and 30b₁ for preventing the dropping out are formed on the end portion of the parallel legs 30a and 30b so that it is possible to prevent parallel legs 30a and 30b from being dropped out from the supporting holes 31a and 31b.

In the movable mechanism of the belt clip, it is possible to engage and hold the belt clip 16 at arbitrary moving positions relative to the telephone set body 11 by forming teeth 32 and 33 on the sides of the telephone set body 11 and the parallel legs 30a and 30b, which engage with each other as shown in FIG. 10.

The embodiments of the present invention are explained as described above. However, the present invention is not limited to these embodiments and it is obviously applied to various embodiments in addition to the above described embodiments. Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A portable telephone set having a holding member, which is attached to said portable telephone set body to hold said body by hooking it up on a user's belt, wherein said holding member is attached movably and stored in a storage portion of said portable telephone set body when said holding member is not used.

2. The portable telephone set according to claim 1, wherein, in the state that said holding member is stored in said storage portion, a front face of said holding member constitutes the same level as that of the front face of said telephone set body and said holding member comprises a portion of an outer shape of said telephone set body.

3. The portable telephone set according to claim 1, wherein an engagement mechanism is disposed to hold and engage said holding member at the storage position and at the available position, respectively.
